(19) United States
(12) Patent Application Publication
(10) Pub. No.: US 2006/0130881 A1
(43) Pub. Date: Jun. 22, 2006

(54) Method of cleaning optical tools for making contact lens molds using super-cooled fluids

(76) Inventors: Sanjay Rastogi, Rochester, NY (US); Mahendra Nandu, Pittsford, NY (US)

Correspondence Address: Bausch & Lomb Incorporated, One Bausch & Lomb Place, Rochester, NY, 14604-2701, US

(21) Appl. No.: 11/313,469

(22) Filed: Dec. 21, 2005

Related U.S. Application Data
(60) Provisional application No. 60/638,237, filed on Dec. 21, 2004.

(51) Int. Cl. B08B 3/00; B29D 11/00

(52) U.S. Cl. 134/34; 264/28; 264/1.32; 264/2.5

(57) ABSTRACT

The present invention includes a process for cleaning an optical tool for manufacturing contact lens molds comprising contacting the optical tool with a super-cooled fluid under conditions effective to clean the optical tool.

### CROSS REFERENCE

This application claims the benefit of Provisional Patent Application No. 60/638,237 filed Dec. 21, 2004 and is incorporated herein by reference.

### BACKGROUND OF THE INVENTION

1. Field of the Invention

This invention relates generally to a method of manufacturing molds and/or mold halves for contact lenses and more particularly to a method of cleaning an optical tool for forming contact lens molds and/or mold halves.

2. Discussion of the Related Art

Most contact lenses are molded in disposable polyethylene or polypropylene molds. Specifically, a contact lens is made of two mold halves. The anterior mold half defines the convex surface of the contact lens. The posterior mold half defines the concave surface of the contact lens. During the molding process, a predetermined amount of a pre-polymer mixture is placed in the anterior mold half and the posterior mold half is pressed against the anterior mold half forming the desired shape of the contact lens. After the mold halves are placed together a curing step occurs. In one embodiment, the curing step occurs by application of ultraviolet light that catalyzes a polymerization reaction.

The contact lens is removed from the two disposable mold halves and further processed and packaged. The extraction of the lens typically renders the disposable mold halves unusable. Thus the disposable mold halves are discarded after single use.

The disposable mold halves are made by the injection of polyethylene or polypropylene polymer into a preformed optical tool with a cavity shaped to the desired dimensions of the mold half. “Optical tool” as used herein is defined as a tool with optical quality finish capable of creating optical quality disposable molds for manufacturing optical quality lenses. The manufacture of the disposable molds require a high degree of precision since the disposable molds will effect the optical properties of the contact lens that are produced by the disposable molds. Any debris on the mold would produce a defective contact lens. Likewise, any debris on the optical tool that forms the disposable molds could create a mass number of defective molds. One way that an optical tool can produce defective molds is when the optical tool is unclean. Presently, optical tools are cleaned before being mounted on the injection-molding equipment by rinsing the optical tool in a bath of isopropyl alcohol. The alcohol effectively removes debris and dissolves any grease. Once the optical tool is removed from the alcohol bath, the alcohol quickly evaporates from the surface leaving a clean dry optical tool ready for mounting.

Alcohol is an effective cleaning agent. However, the evaporation of a hydrocarbon into the atmosphere is preferably avoided for safety, environmental and health reasons. Moreover, the alcohol bath eventually needs to be replaced with a clean bath and requires expensive disposal or recycling.

Thus, there exists a need for an effective cleaning agent that does not require recycling and/or cause the release of hydrocarbons into the atmosphere. The present invention addresses these and other needs.

### SUMMARY OF THE INVENTION

The present invention is a process for cleaning an optical tool for manufacturing contact lens molds. The process comprises contacting the optical tool with a super-cooled fluid under conditions effective to clean the optical tool. In one embodiment the conditions are effective to remove particulate debris from the optical tool. In another embodiment, the conditions are effective to remove residue from the optical tool. For example, the residue is a hydrophobic residue—particularly an oil residue.

A super-cooled fluid is defined as a temperature below minus 30° C. In one embodiment, the super-cooled fluid is at a temperature below about minus 40° C. Typically, the temperature is below about minus 50° C., about minus 60° C., about minus 70° C. Typically, the super-cooled fluid is a cryogenic fluid.

In one embodiment, the super cooled fluid is in the liquid state. In another embodiment, the super-cooled fluid is stored in a liquid state but contacts the surface to be cleaned in a vapor state.

In one embodiment, the super-cooled fluid is selected from the group consisting essentially of nitrogen, argon, helium, and carbon dioxide. Preferably, the super-cooled fluid is an inert atmospheric gas. More preferably, the super-cooled fluid is nitrogen.

A process for manufacturing a mold or mold half for a contact lens is a subject of another embodiment of the present invention. An optical tool is made having at least one cavity sized and configured to make a contact lens mold half. The optical tool is cleaned by contacting the optical tool with a super-cooled fluid under conditions effective to clean the optical tool. The optical tool is mounted on an injection-molding machine. A plastic from the group comprising polyethylene, polypropylene and mixtures thereof is injected into the optical tool to form a mold half.

In an embodiment, there is a process for manufacturing contact lenses. The process comprises making a mold or mold halve according to one or more embodiments described herein. Thereafter, the process includes forming contact lenses in the mold or with mold halves.

In still another embodiment, there is a process for manufacturing an optical tool used to make injected molded mold halves for contact lenses. The process comprises the step of making an optical tool having at least one cavity for making a contact lens. Then, the optical tool is with a super-cooled fluid under conditions that effective to clean the optical tool.

### DETAILED DESCRIPTION OF THE INVENTION

The present invention is a process for cleaning an optical tool for manufacturing contact lens molds. The process comprises contacting the optical tool with a super-cooled fluid under conditions effective to clean the optical tool.

The mold sections may be injection molded from the thermoplastic polyolefin resin by methods, which are otherwise known in the art. See U.S. Pat. Nos. 5,271,875, 5,843,346 and 6,582,631, which are incorporated herein by reference in their entirety. The optical tools for the injection-molding are typically made from brass, stainless steel or nickel or some combination thereof. A preferred material for use with this invention is nickel-plated brass. A desired surface is machined and polished on the optical tools to achieve precision surface quality so that no surface imperfections are transferred to the mold section being injection molded therefrom. Understandably, any residue or particulate debris on the optical tool surface would result in defects of the lens molds or mold halves.

In one embodiment the process of cleaning the optical tool by contacting the optical tool with a super cooled fluid is effective to remove particulate debris from the optical tool. In another embodiment, the conditions are effective to remove residue from the optical tool. For example, the residue is a hydrophobic residue—particularly an oil residue. In another embodiment, the residue is a hydrophilic residue.

In one embodiment, the conditions include contacting the optical tool with the super-cooled fluid for a period of time effective to clean the optical tool.

In another embodiment, the period of time that is effective to clean the optical tool is a minimum of about 0.1 seconds and a maximum of about 20 seconds. Typically, the period of time effective to clean the optical tool is a minimum of about 0.1 seconds, about 0.5 seconds, about 1.0 seconds, about 2.0 seconds or about 5.0 seconds. Generally, the period of time effective to clean the optical tool is a maximum of about 20 seconds, about 15 seconds, about 10 seconds, about 5 seconds, about 3 seconds, about 2 seconds or about 1 second.

According to one embodiment, the contacting occurs by any mean know in the art to contact a super-cooled or cryogenic fluid with an optical tool. In one embodiment, the optical tool is immersed in a bath containing the super-cooled fluid. In another embodiment, the contacting occurs by dipping at least a portion of the optical tool in a bath containing the super-cooled fluid.

According to one method of contacting a super-cooled fluid with an optical tool occurs by spraying the super-cooled fluid at the optical tool or alternatively contacting a stream of super-cooled fluid in contact with the optical tool.

The super-cooled fluid is defined as a liquid that is at a maximum temperature of about minus 30° C. or a fluidized mixture of liquid or solid particles in a gaseous medium at a temperature of about minus 30° C. In one embodiment, the super-cooled fluid is at a maximum temperature of about minus 40° C. Typically, the temperature is a maximum about minus 50° C., about minus 60° C. or about minus 70° C. Typically, the super-cooled fluid is a cryogenic fluid. A cryogenic fluid is a liquid substance that is at a maximum temperature of minus 100° C.

In one embodiment, the super-cooled fluid is selected from the group consisting essentially of nitrogen, argon, helium, and carbon dioxide. Preferably, the super-cooled fluid is an inert atmospheric gas. More preferably, the super-cooled fluid is nitrogen.

Once the optical tools are cleaned and the temperature of the mold has returned to at least ambient temperature, a molten plastic material is injected into the mold optical tool to form mold halves and mold pairs. In one embodiment, the mold halves are for spherical lenses. In another embodiment, the mold pairs are intended to form asymmetric lenses.

While not entirely necessary, it is advantageous for the mold material to have a suitable melt flow rate (MFR). Plastic materials suitable for injection-molding that are capable of having the appropriate melt flow rate included polypropylene resins available under the trademark PRO-FAX SR-011 and PRO-FAX SB-751 (Himont, Incorporated, Wilmington, Del.), MFR 21 and 30, respectively; the polypropylene resins available under the trademark ESCORENE PP1434F1 and PP1105F1 (Exxon Chemical Co., Houston, Tex.), MFR 25 and 35, respectively; the polypropylene resin available under the trademark MARLEX HGZ-350 (Phillips 66 Corporation, Houston, Tex.), MFR 35; and the polypropylene resin available under the trademark UNIPOL PP 7C12N (Shell Chemical Co., Houston, Tex.) and MFR 22.

In another embodiment, alternative suitable materials include engineering resins. The engineering resins are generally amorphous polymers regarded as offering higher mechanical and physical properties than thermoplastic polyolefin resins. The amorphous polymers include polyethylenterephthalate, polystyrene polycarbonate and copolymer of ethylene and cyclic olefins. Process for the use of copolymers of ethylene and cyclic olefins are disclosed in PCT Publication WO9947344.

The mold halves are then used in an injection-molding process for making contact lenses. The contact lenses are free of defects due to the cleaning of the optical tool making the mold pairs and mold halves.

Hydrogels represent one class of materials used for many device applications, including ophthalmic lenses. Hydrogels comprise a hydrated, cross-linked polymeric systems containing water in an equilibrium state. Accordingly, hydrogels are copolymers prepared from hydrophilic monomers. In the case of silicone hydrogels, the hydrogel copolymers are generally prepared by polymerizing a mixture containing at least one device-forming silicone-containing monomer and at least one device-forming hydrophilic monomer. Either the silicone-containing monomer or the hydrophilic monomer may function as a crosslinking agent (a crosslinking agent being defined as a monomer having multiple polymerizable functionalities), or alternately, a separate crosslinking agent may be employed in the initial monomer mixture from which the hydrogel copolymer is formed. Silicone hydrogels typically have a water-content between about 10 to about 80 weight percent.

Examples of useful device-forming hydrophilic monomers include: amides such as N,N-dimethylacrylamide and N,N-dimethylmethacrylamide; cyclic lactams such as N-vinyl-2-pyrrolidone; (meth)acrylated alcohols, such as 2-hydroxyethylmethacrylte and 2-hydroxyethylacrylate; and (meth)acrylated poly(alkene glycols), such as poly(diethylene glycols) of varying chain length containing monomethacrylate or dimethacrylate end caps. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277, the disclosures of which are incorporated herein by reference. Other suitable hydrophilic monomers will be apparent to one skilled in the art.

As mentioned, one preferred class of medical device materials is silicone hydrogels. In this case, the initial device-forming monomer mixture further comprises a silicone-containing monomer.

Applicable silicone-containing monomeric materials for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Another class of silicon-containing monomers includes polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol. 60, 1193-1199 (1996). PCT Published Application No. WO 96/31792 discloses examples of such monomers.

Other examples of materials that may be used in the manufacture of contact lenses according to the present invention are found in U.S. Pat. No. 5,908,906 to Künzler et al.; U.S. Pat. No. 5,714,557 to Künzler et al.; U.S. Pat. No. 5,710,302 to Künzler et al.; U.S. Pat. No. 5,708,094 to Lai et al.; U.S. Pat. No. 5,616,757 to Bambury et al.; U.S. Pat. No. 5,610,252 to Bambury et al.; U.S. Pat. No. 5,512,205 to Lai; U.S. Pat. No. 5,449,729 to Lai; U.S. Pat. No. 5,387,662 to Künzler et al. and U.S. Pat. No. 5,310,779 to Lai; the disclosures of which are incorporated herein by reference.

In another embodiment, the materials molded form hard contact lenses including rigid gas permeable lenses. Examples of conventional RGP materials are well known in the art and include silicone acrylate copolymers and fluorosilicon acrylate copolymers. Representative silicone acrylate RGP materials include copolymers of a siloxane (meth) acrylate monomer (such as tris(trimethylsiloxy) silylpropyl methacrylate), a hydrophilic wetting monomer (such N-vinyl pyrrolidone or methacrylic acid), a crosslinking monomer (such as monomers having two terminal (meth) acrylate radicals), and a hardening monomer (such as methyl methacrylate or dimethyl itaconate). Fluorosilicon acrylate RGP materials include a fluorinated comonomer; for example, a fluorinated (meth) acrylate or fluorinated itaconate comonomer is included in place of, or in addition to, the non-fluorinated hardening monomer. Representative RGP materials are disclosed in U.S. Pat. No. 4,152,508 (Ellis et al.), U.S. Pat. No. 3,808,178 (Gaylord), U.S. Pat. No. 4,686,267 (Ellis et al.) and U.S. Pat. No. 4,780,515 (Deichert).

In addition to the present invention being used to make contact lenses, the present invention can be used to make intraocular lenses (IOLs). The present method of cleaning the optical tool results in high quality cleaning without the burden of disposing waste materials. The super cooled fluids of one embodiment, do not require disposal when they liquefy upon contact with the optical tool. The use of super-cooled or cryogenic fluids from gasses that occur naturally in the air are preferable because they do not pollute the environment and do not require expensive waste disposal and recycling. Moreover, they do not produce fumes that can be harmful to the individuals cleaning the mold.

What is claimed is:

1. A process for cleaning an optical tool for manufacturing contact lens molds comprising contacting the optical tool with a super-cooled fluid under conditions effective to clean the optical tool.

2. The process of claim 1, wherein the conditions are effective to remove particulate debris from the optical tool.

3. The process of claim 1, wherein the conditions are effective to remove residue from the optical tool.

4. The process of claim 1, wherein the residue is a hydrophobic residue.

5. The process of claim 1, wherein the residue is an oil residue.

6. The process of claim 1, wherein the residue is a hydrophilic residue.

7. The process of claim 1, wherein the conditions include contacting for a period of time effective to clean the optical tool.

8. The process of claim 7, wherein the period of time that is a minimum of about 0.1 seconds to a maximum of about 20 seconds.

9. The process of claim 1, wherein the contacting occurs by immersing the optical tool in a bath containing the super-cooled fluid.

10. The process of claim 1, wherein the contacting occurs by dipping at least a portion of the optical tool in a bath containing the super-cooled fluid.

11. The process of claim 1, wherein the contacting occurs by spraying the super-cooled fluid at the optical tool.

12. The process of claim 1, wherein the super-cooled fluid is at a temperature below minus 40° C.

13. The process of claim I, wherein the super-cooled fluid is selected from the group consisting essentially of nitrogen, argon, helium, and CO₂.

14. A process for manufacturing contact lenses, comprising the steps of:
making an optical tool having at least one cavity for making a contact lens;
cleaning the optical tool by contacting the optical tool with a super-cooled fluid under conditions effective to clean the optical tool;
mounting the optical tool on an injection-molding machine;
injecting a plastic from the group comprising polyethylene, polypropylene and mixtures thereof into the optical tool to form a batch of molds and/or mold halves; and
forming contact lenses in the molds and/or mold halves.

15. The process of claim 14, wherein the conditions are effective to remove particulate debris from the optical tool.

16. The process of claim 14, wherein the conditions are effective to remove residue from the optical tool.

17. The process of claim 14, wherein the residue is a hydrophobic residue.

18. The process of claim 14, wherein the residue is an oil residue.

19. The process of claim 14, wherein the residue is a hydrophilic residue.

20. The process of claim 14, wherein the conditions include contacting for a period of time effective to clean the optical tool.

21. The process of claim 20, wherein the period of time that is a minimum of about 0.1 seconds to a maximum of about 20 seconds.

22. The process of claim 14, wherein the contacting occurs by immersing the optical tool in a bath containing the super-cooled fluid.

23. The process of claim 14, wherein the contacting occurs by dipping at least a portion of the optical tool in a bath containing the super-cooled fluid.

24. The process of claim 14, wherein the contacting occurs by spraying the super-cooled fluid at the optical tool.

25. The process of claim 14, wherein the super-cooled fluid is at a temperature below minus 40° C.

26. The process of claim 14, wherein the super-cooled fluid is selected from the group consisting essentially of nitrogen, argon, helium, and carbon dioxide.

27. A process for manufacturing a mold or mold half for a contact lens, comprising the steps of:
making an optical tool having at least one cavity for making a contact lens;
cleaning the optical tool by contacting the optical tool with a super-cooled fluid under conditions effective to clean the optical tool;
mounting the optical tool on an injection-molding machine;
injecting a plastic from the group comprising polyethylene, polypropylene and mixtures thereof into the optical tool to form a batch of molds and/or mold halves.

28. The process of claim 27, wherein the conditions are effective to remove particulate debris from the optical tool.

29. The process of claim 27, wherein the conditions are effective to remove residue from the optical tool.

30. The process of claim 27, wherein the residue is a hydrophobic residue.

31. The process of claim 27, wherein the residue is an oil residue.

32. The process of claim 27, wherein the residue is a hydrophilic residue.

33. The process of claim 27, wherein the conditions include contacting for a period of time effective to clean the optical tool.

34. The process of claim 33, wherein the period of time that is a minimum of about 0.1 seconds to a maximum of about 20 seconds.

35. The process of claim 27, wherein the contacting occurs by immersing the optical tool in a bath containing the super-cooled fluid.

36. The process of claim 27, wherein the contacting occurs by dipping at least a portion of the optical tool in a bath containing the super-cooled fluid.

37. The process of claim 27, wherein the contacting occurs by spraying the super-cooled fluid at the optical tool.

38. The process of claim 27, wherein the super-cooled fluid is at a temperature below minus 40° C.

39. The process of claim 27, wherein the super-cooled fluid is selected from the group consisting essentially of nitrogen, argon, helium, and carbon dioxide.

40. A process for manufacturing an optical tool for manufacturing mold halves for contact lenses, comprising the steps of:
making an optical tool having at least one cavity for making a contact lens; and
cleaning the optical tool by contacting the optical tool with a cryogenic fluid under conditions effective to clean the optical tool.

41. The process of claim 40, wherein the conditions are effective to remove particulate debris from the optical tool.

42. The process of claim 40, wherein the conditions are effective to remove residue from the optical tool.

43. The process of claim 40, wherein the residue is a hydrophobic residue.

44. The process of claim 40, wherein the residue is an oil residue.

45. The process of claim 40, wherein the residue is a hydrophilic residue.

46. The process of claim 40, wherein the conditions include contacting for a period of time effective to clean the optical tool.

47. The process of claim 46, wherein the period of time that is a minimum of about 0.1 seconds to a maximum of about 20 seconds.

48. The process of claim 40, wherein the contacting occurs by immersing the optical tool in a bath containing the super-cooled fluid.

49. The process of claim 40, wherein the contacting occurs by dipping at least a portion of the optical tool in a bath containing the super-cooled fluid.

50. The process of claim 40, wherein the contacting occurs by spraying the super-cooled fluid at the optical tool.

51. The process of claim 40, wherein the super-cooled fluid is at a temperature below minus 40° C.

52. The process of claim 40, wherein the super-cooled fluid is selected from the group consisting essentially of nitrogen, argon, helium, and carbon dioxide.
